(19) United States
(12) Patent Application Publication
(10) Pub. No.: US 2011/0078552 A1
(43) Pub. Date: Mar. 31, 2011

(54) Transclusion Process

(76) Inventors: John William Lumley, Bristol (GB); Angelo Dl Lorio, Bologna (IT); Steven Battle, Bristol City (GB)

(21) Appl. No.: 12/568,769

(22) Filed: Sep. 29, 2009

(51) Int. Cl. G06F 17/00

(52) U.S. Cl. 715/234

(57) ABSTRACT

A first version of a target document includes a source reference to a source element of a source document. A transclusion processor writes a second element to a second version of the target document. The second element is a copy of the source element that includes a provenance reference to the source element as an attribute.

### BACKGROUND

Herein, related art is described for expository purposes. Related art labeled “prior art”, if any, is admitted prior art; related art not labeled “prior art” is not admitted prior art.

Documents can be composed collaboratively in whole or in part by including sections from other “source” documents. For example, a contract document may require portions of a company's standard terms and conditions that might be described in another set of documents. To avoid duplication, the contract may be originally constructed by copying appropriate portions of the terms and conditions or by inserting a directive to include those sections. At some stage, the document is processed to draw in all those pieces. If the document is dynamic (for example, the contract is being negotiated), it may be that the terms and conditions required will alter and the inclusion will have to be reprocessed.

### BRIEF DESCRIPTION OF THE DRAWING

FIG. 1 is a schematic diagram of a document processing system.

### DETAILED DESCRIPTION

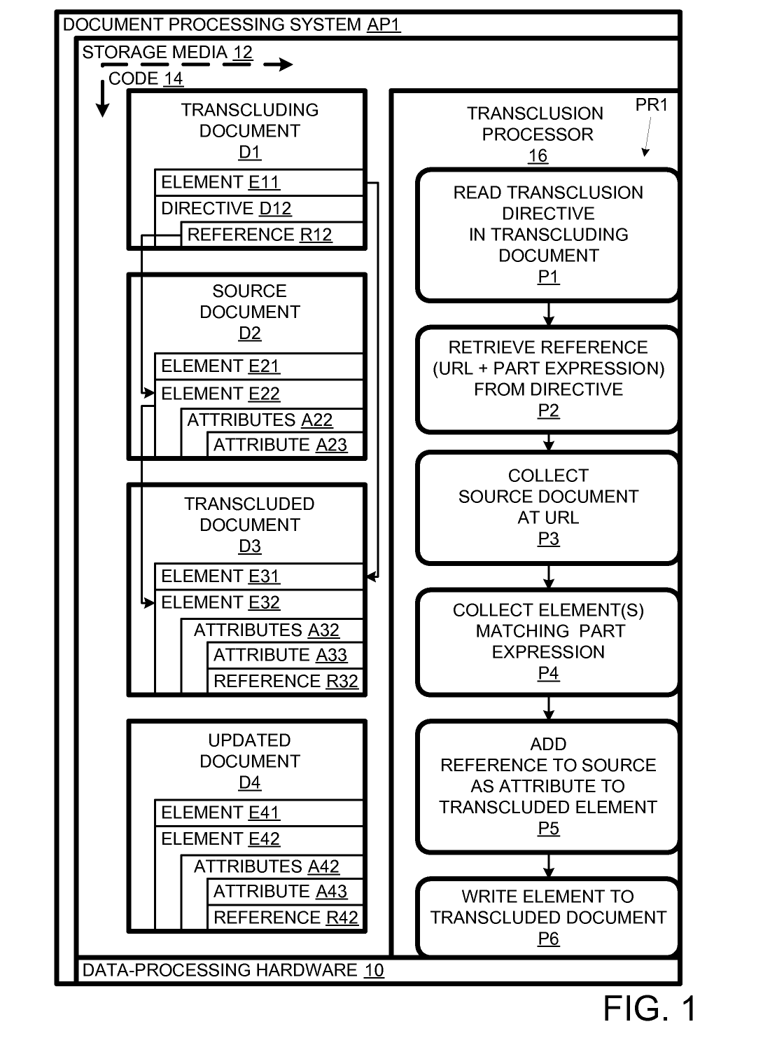

In document processing system AP1, shown in FIG. 1, location references to sources of elements of a document are stored as XML (or other mark-up language) attributes. The references can be used by a transclusion processor for including an element from a source document into a target document so that the copy in the target document can be dynamically updated to reflect changes in the source element. Within XML, attributes attached to elements are considered to be an extensible dimension that does not conflict with the major structure and semantic meaning of the document, expressed as elements, children and text components. Since the location reference is in the form of a mark-up language attribute, sources are readily identified in a manner that does not affect presentation or other document processing not involving transclusion.

Document processing system AP1 includes data-processing hardware 10 and computer-readable storage media 12, as shown in FIG. 1. Hardware 10 can include integrated-circuit processors, network and other communications devices, and input-output devices. Media 12 is encoded with code 14, which can include both instructions and data. In particular, code 14 defines a transclusion processor 16, which is realized through an interaction of program instructions and hardware 10. In addition, code 14 can define one or more documents such as a transcluding document D1, a source document D2, a transcluded document D3, and an updated transcluded document D4. Documents D1, D3, and D4 are alternatively referred to herein as versions of a single target document.

Transclusion processor 16 transforms physical states of media 12 by creating, deleting, and modifying physical encodings of documents in accordance with a process PR1, flow charted in FIG. 1. At process segment P1, in response to a transclusion command, transclusion processor 16 reads a directive in a transcluding document (a document that includes transclusion directives). The command can be to execute a single transclusion directive or all transclusion directives in a document. For example, transcluding document D1 includes an element E11, e.g., content that is original to document D1, and a directive D12 to transclude an element E22 from source document D2.

The following is an example of a transclusion directive. <tc:transclude source=“X.xml” part=“.//h1” process=“greedy”/> where: tc: is bound to some transclusion-reserved namespace; source points to a document from which content is to be transcluded, in this case another document X.xml, which presumably is accessible from the context of the document in focus; part describes some parts of that document required—in this case .//h1 which for this example is taken to be an XPath expression—one that would select all the ‘heading 1’ elements within the document; and process is some declaration on how this directive should be (re)processed, including when this directive itself (or content it has brought in) may be transcluded.

Process segment P2 involves retrieving a source-locating reference from the directive. In general, a directive will include a sequence of one or more references to elements to be transcluded. These may be from a single document or from multiple document. For each source document, the reference specifies a uniform resource locator (URL) (or other network location) and a part expression indicating a location within a document at which the desired element can be found. For example, directive D12 specifies a reference R12 that includes a uniform resource locator (URL) to source document D2 and a part expression that indicates a location within document D2 at which element E22 can be found.

At process segment P3, transclusion processor 16 collects the source document. The transcluding document and the transclusion processor can be on one or more local (from the perspective of the user) computers, while the source document can be located remote location accessed over the Internet or other network. In such a case, a local copy of the source document can be made so that it can be more readily reviewed and searched. The copy can be exact or a version constructed to facilitate reviewing or searching.

At process segment P4, transclusion processor 16 collects the element within the collected document that matches the part expression of the reference. If the directive being processed refers to several elements of one or more documents, these elements are collected in the order specified in the reference. The element(s) can be collected from the source document (e.g., if process segment P3 is omitted), or from the local copy.

A collected element may have attributes such as font characteristics or document structure attributes (chapter heading, subheading, etc.). For example, element E22 of document D2 has a set of attributes A22, one of which is attribute A23. Also, the source document may have elements that are not collected; for example, source document D2 includes an element E21 that is not collected at process segment P4.

At process segment P5, a reference to the source is added as an attribute to the collected element. If more than one element is collected, a reference can be added to each collected element. For example, the added reference can specify a URL and a part expression, e.g., XPath, uniquely identifying the source of the collected element. For example, the added reference can be an additional attribute of attributes A22 of element E22.

At process segment P6, the collected element is written to the transcluded document, which is basically the transcluding document with the transclusion elements replacing directives. The transcluded document can be created and then the element can be written; alternatively, the element can be written to the document as it is generated.

Accordingly, transcluded document D3 includes element E31, which is a copy of element E11 of transcluding document Dl. In addition, transcluded document D3 includes element E32, which is the copy of source element E22 that replaces directive D12. Transcluded element E32 includes a set of attributes A32, one of which is attribute A33 corresponding to attribute A22 of element E22. In addition, attributes A32 of element E32 include a reference attribute R32, specifying a URL and part expression pointing to element E22 of document D2.

Process PR1 can also be used to update a transcluded document so that existing elements are replaced by updated versions of elements in the source document. In response to an update command, process segment P2 can involve retrieving a provenance reference in a transcluded document. For example, reference R32 can be read from element E32 of transcluded document D3. Process segments P3-P6 can then be executed to yield an updated transcluded document. In this case, updated document D4 includes an element E41, corresponding to element E31 of document D3, and element E42, corresponding to an updated version of element E22 of source document D2. In this case, a set of attributes A42, including attribute A43 and reference R42, correspond to attributes A32, including attribute A33 and reference R32. Process PR1 through process segment P4 can also be used to retrieve the source without updating a document.

The source element can itself be transcluded from a second source document. In other words, if the element being transcluded is already marked with these attributes, their original values are concatenated with the new ones to produce sequence-valued ones (e.g. X.xml#.//h1; B.xml#div[@class=‘appendix’]—in which some of the heading elements in X.xml had actually come from the appendix of a document B.xml). For another example, attribute A22 can be a reference to a second source document. In such a case, references to both the first and second source documents can be included with a transcluded element. For example, attribute A33 can be a reference to a second source document just as reference R32 is a reference to a source document D2. Process PR1 provides for collecting or updating an element for the source of the source as well as from the source itself.

In some cases, process PR1 may fail to locate a source document or an element within a source document that is found. For example, a directive may point to a contract provision that has not been prepared or source of a transcluded element may have been deleted. In such cases, there is no element to which to attach a provenance reference. Instead, the unfulfilled reference can be attached to the document, e.g., as part of the header or other data structure, along with a pointer to the location in the transcluded document that the element would have been had it been found. This makes it possible for the desired element to be sought and found in a later transclusion operation if it has reappeared in the source.

Each provenance attribute, e.g., references R32 and R42 can have an associated identity value that can be used to tie a transclusion to log or database of transclusion actions. Such a log or database can indicate a date and time and a user for each transclusion.

A transcluded document may then be stored or processed by other tools. For most processing there is no difference at all between elements that have been transcluded (or indeed multiply transcluded) and those that are not—only the presence of the transclusion marking attributes would indicate and transclusion-ignorant tools, behaving as good XML citizens, will retain functionally correct behavior.

For tools that are transclusion-aware (principally systems to refresh and update interlinked document sets, allow users to explore source provenance and so forth and editors of XML documents) there is complete information on the result document to: 1) find the ultimate original source document for an element; 2) to view that source, or alter that element in its original source view and/or modify any of the intermediate transclusion directives; 3) examine or change both the ‘name’ of the document transcluded or the description of the parts required and do this at any level; 4) delete a transclusion directive completely; and 5) reconstruct the original source document containing only the outermost elements and the topmost transclusion directives.

Herein a “document” is a file that includes content to be displayed or otherwise presented to a user. Examples include text files, word processing documents, spreadsheets, images, video, etc. Herein, “transclusion” refers to a dynamically updateable inclusion of an element from a source (typically involving a reference to the source that can be used to update the target document to reflect an update to the source). Herein, a “system” is any set of elements that interact to yield a result that is greater than the sum of the parts. Examples of systems include mechanical machines, electronic devices, and media encoded with programs of computer-executable instructions. “Referring” herein denotes “specifying a location”. A “provenance reference”, herein, is a source or locating reference to the source of an element. A “mark-up language attribute” is an attribute as defined by an associated mark-up language such as XML or HTML.

In system API, transclusion can be used as a systematic, uniform and complete method for the composition of documents, without the majority of processing tools having to be aware at all of the existence of such a mechanism. Complete source provenance is attached to the transcluded content in such a way that further (good-citizen) XML processing of those documents does not destroy the provenance on final results and tools that need to be aware of such provenance (such as view-based editors or auditing systems) can still operate correctly. The disclosed transclusion processor can also be used as a reverse channel to edit a source document from a target document. The described and other variations upon and modifications to the illustrated embodiment are provided for by the subject matter defined in the following claims.

What is claimed is:

1. A computer-implemented transclusion process comprising:
retrieving a source-locating reference to first element of a first source document from a first version of a target document;
collecting said first element;
including in a second element a first provenance reference to said first element, said second element being at least a partial copy of said first element; and
including said second element with said first provenance reference in a second version of said target document.

2. A transclusion process as recited in claim 1 wherein said source-locating reference is specified by a transclusion directive.

3. A transclusion process as recited in claim 1 wherein said source-locating reference is specified by an attribute of an element of said first version of said target document.

4. A transclusion process as recited in claim 1 wherein said versions of target documents are XML documents.

5. A transclusion process as recited in claim 1 wherein said element includes as an attribute a second provenance reference to a third element of a second source document, said first provenance reference referring to said first source document and said second source document.

6. A system comprising computer-readable storage media encoded with code defining:
a transclusion processor for writing a second element into a second version of a target document so that said second element includes as a mark-up language attribute a first provenance reference to a first element of which said second element is at least a partial copy, said first element being included in a first source document referred to by a source reference included in a first version of said target document.

7. A system as recited in claim 6 wherein said source reference is an attribute of a third element included in said first version of said target document.

8. A system as recited in claim 6 wherein said source reference is specified by a transclusion directive of said first version of said target document.

9. A system as recited in claim 6 wherein first element includes as an attribute a second provenance reference to a third element of a second source document, said first provenance reference referring to said first and third elements.

10. A system as recited in claim 6 wherein said versions of said target documents are XML documents.

11. A system as recited in claim 6 further comprising data-processing hardware for executing said transclusion processor.

12. A system as recited in claim 11 wherein said source reference is an attribute of a third element included in said first version of said target document.

13. A system as recited in claim 11 wherein said source reference is specified by a transclusion directive of said first version of said target document.

14. A system as recited in claim 11 wherein first element includes as an attribute a second provenance reference to a third element of a second source document, said first provenance reference referring to respectively to said first and third elements.

15. A system as recited in claim 11 wherein said source reference is an attribute of a third element included in said first version of said target document.
